(19) United States
(12) Patent Application Publication
(10) Pub. No.: US 2010/0094482 A1
(43) Pub. Date: Apr. 15, 2010

(54) VEHICLE TRACKING SYSTEM

(76) Inventors: Kenneth Schofield, Holland, MI (US); Keith J. Vadas, Caledonia, MI (US); Donell Richardson, Rocky Mount, NC (US); Clayton Raybourn, South Lyon, MI (US); James Kemp, Troy, MI (US)

Correspondence Address: BUTZEL LONG;IP DOCKETING DEPT, 350 SOUTH MAIN STREET, SUITE 300, ANN ARBOR, MI, 48104, US

(21) Appl. No.: 12/177,135

(22) Filed: Jul. 21, 2008

Related U.S. Application Data
(60) Provisional application No. 60/951,008, filed on Jul. 20, 2007.

(51) Int. Cl. G06F 17/00

(52) U.S. Cl. 701/2; 701/300

(57) ABSTRACT

A vehicle tracking system comprising a vehicle tag capable of sending and receiving wireless signals and associated with a vehicle; and a locator device capable of sending and receiving wireless signals to and from said vehicle tag and determining relative position of said vehicle to said locator device by communicating with said vehicle tag.

### CROSS-REFERENCE TO RELATED PATENT APPLICATIONS

This application claims the benefit of, and priority to, U.S. Provisional Patent Application No. 60/951,008, filed Jul. 20, 2007, which is incorporated by reference herein.

### BACKGROUND OF THE INVENTION

The present invention relates generally to a communications network and, more particularly, to a system and method for locating and obtaining vehicle information.

Wireless networks are becoming more commonplace in offices, homes, and even cities. While these common wireless networks a good at transmitting signals to send messages and information between nodes on the network, most wireless networks do not provide capability to determine the location of a wireless node. In vehicles and cell phones, the use of a global positioning satellite (GPS) is often used to determine location. However, use of a GPS goes beyond the area of a local network and is not often a cost effective method for determining the location of a network node. Further, with the number of different wireless communications standards it is difficult to find one node that will operate on all networks and therefore it is desirable to build a network that accommodates multiple wireless communications standards.

It is also desirable for businesses and individuals to be able to track their assets utilizing a location determination system but it is not cost effective for them to do so utilizing GPS. In addition, many tracking systems are only useful for one purpose and instead it would be desirable to have a tracking system that could operate on a local network and provide a multitude of functions for various users of the asset. A prime example is a vehicle. It is advantageous for a vehicle dealership, for example, to use wireless signals to track vehicles in inventory but it is even more advantageous to provide a system that allows for dealerships to accomplish this and that also allows the buyer of the car to also use functions of the system. Therefore, it is an object of the present invention to provide a unified system for tracking of objects that is scalable and configurable to provide usefulness to a variety of entities

### SUMMARY OF THE INVENTION

The present invention concerns a communication system and more particularly a system and method for identifying, tracking, and/or controlling vehicles via wireless communications signals. In one aspect of the present invention, there is vehicle tracking system comprising a vehicle tag capable of sending and receiving wireless signals and associated with a vehicle and a locator device capable of sending and receiving wireless signals to and from the vehicle tag and determining the relative position of the vehicle to said locator device by communicating with the vehicle tag. In another aspect of the present invention, the vehicle has an electrical control system and the vehicle tag is operatively connected to the electrical system to allow the locator device to obtain vehicle information wirelessly. In yet another aspect of the present invention, the locator device is able to control vehicle functions remotely by communicating with the vehicle tag.

### DESCRIPTION OF THE DRAWINGS

The above, as well as other, advantages of the present invention will become readily apparent to those skilled in the art from the following detailed description of a preferred embodiment when considered in the light of the accompanying drawings in which:

FIG. 1 is a schematic of a two node network in accordance with the present invention;

FIG. 2 is a schematic of a key fob in accordance with the present invention;

FIG. 3 is a schematic of a node electrically connected with a vehicle electrical system in accordance with the present invention;

FIG. 4 is a schematic of a two node network in accordance with the present invention;

FIG. 5 is a schematic of two node network in accordance with the present invention;

FIG. 6 is a schematic of two node network in accordance with the present invention;

FIG. 7 is a schematic of a multi-node network in accordance with the present invention;

FIG. 8 is a schematic of a multi-node network in accordance with the present invention;

FIG. 9 is a schematic of a multi-node network in accordance with the present invention;

FIG. 10 is a schematic of a multi-node network in accordance with the present invention;

FIG. 11 is a schematic of a multi-node network in accordance with the present invention;

FIG. 12 is a schematic of a multi-node network in accordance with the present invention;

FIG. 13 is a schematic of a multi-node network in accordance with the present invention;

FIG. 14 is a schematic of the dealer asset tracking system of the present invention;

FIG. 15 is a schematic of the master control unit of the present invention;

FIG. 16 is a flow diagram of remotely controlling the climate control system of a vehicle in accordance with the present invention;

FIG. 17 is a schematic of a parking lot with multiple nodes in accordance with the present invention;

FIG. 18 is a flow diagram of remotely determining the location of a vehicle in accordance with the present invention;

FIG. 19 is a schematic of a vehicle dealership utilizing the dealership asset tracking system in accordance with the present invention; and

FIG. 20 is a flow diagram of locating a vehicle utilizing the dealership asset tracking system in accordance with the present invention.

### DESCRIPTION OF THE PREFERRED EMBODIMENT

The present invention discloses a communication system and more particularly a system and method for identifying, tracking, and/or controlling vehicles. While the preferred application of the system as disclosed herein is for an automobile dealership tracking system, one skilled in the art will appreciate that the communication system disclosed herein has many possible applications which are not limited to use with automobiles. Therefore, the dealership application is meant to be for exemplary purposes and not as a limited use of the system. First, though, a discussion of the network, which is the foundation of the present system, is necessary.

At the most basic level, the network of the present invention consists of a number of nodes. These nodes can be permanently fixed or mobile. The operation of the network depends on the number of nodes connected, or in communication with, the network. Therefore, it is necessary to have at least two nodes but there is no upper limit on the number of possible nodes.

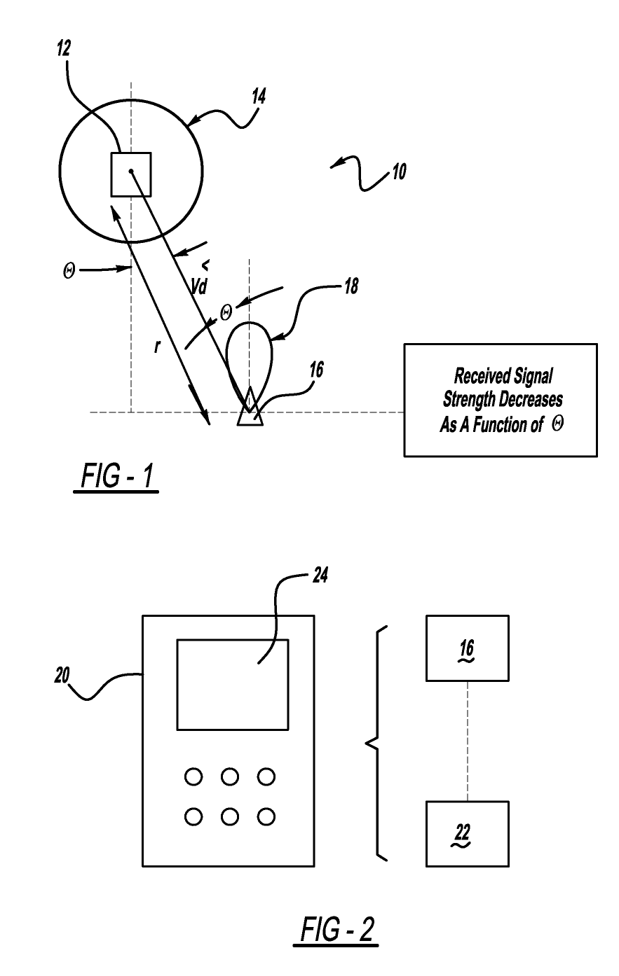

Referring to FIG. 1, the simplest exemplary embodiment of a node communication network with two nodes is shown generally at 10. In this embodiment, one node, the target node 12, is attached to or located within a vehicle and has an antenna such as the omnidirectional antenna shown at 14 in FIG. 1. Referring to FIG. 2, the second node, the locator node 16, is preferably integrated with a key fob 20 as known in the art or is incorporated in a separate device. In this example, the locator node 16 includes a locating system 22 which includes the technology (not shown) necessary to perform the operations described herein. The locator node 16 also has an antenna 18 which is displayed in FIG. 1 as a directional antenna. In this example, both the target node 12 and the locator node 16 are mobile nodes versus fixed nodes. Each of the target node 12 and the locator node 16 are also configured for wireless communication with each other.

With the configuration as shown in FIG. 1, if incorporated with a vehicle, the network 10 would be preferably used most often by a vehicle owner to locate his vehicle in parking areas. For example, when the owner walks into a parking lot full of cars and has forgotten where his vehicle is parked, he would activate the locating system 22 of the locator node 16. Alternatively, the locating system 22 could automatically activate when communication between the locator node 16 and the target node 12 becomes possible. The locating system 22 then uses wireless communication technology to communicate with the target node 12 and then utilizes a ranging technique to determine the location of the target node 12 preferably in terms of direction from and distance from the locator node 16 however the locating system 22 could be configured to only determine direction and not distance.

The present invention contemplates the use of any number of wireless communications protocols such as, but not limited to, any of the 802.11 standards, wireless USB, radio frequency identification (RFID), any protocol developed in the future, or a combination thereof. Enabling the nodes to operate on multiple wireless communications networks would be advantageous for portability to other networks and may also provide operational and performance improvement. The ranging technique used by the locating system 22 to determine the direction and/or distance of the target node 12 from the locator node 16 may be any number of techniques currently known in the art such as triangulation, time-of-arrival (TOA)/time-of-flight (TOF) techniques involving two way ranging, differential time of arrival, one way ranging, time of difference arrival and/or received signal strength indication (RSSI). The ranging technique could also be any ranging technique developed in the future that are capable of use with wireless communications protocols. The locating system 22 may be configured so as to use multiple ranging techniques depending on the situation. Such considerations the locating system 22 may take into consideration include whether there is a line of sight between the nodes 12 and 16, whether the nodes 12 and 16 are in motion with respect to each other, whether at least one of the nodes 12 or 16 has a known location, and/or whether there is a common time base (clock) amongst the nodes 12 and 16 (which one skilled in the art will appreciate is extremely advantageous with TOA/TOF techniques).

Once the locating system 22 determines the location of the target node 12, it leads the owner to his vehicle. The locator node 16 can lead the owner to his vehicle in any number of ways, audibly and/or visually. For example, the locator node 16 (or the device within which it is contained such as the key fob 20) could be equipped so as to emit audible sounds to let the owner know when he is headed in the direction of his vehicle. The audible sounds may be emitted via magnetic speakers, Piezo electronics, or any other type of audio electronics. Alternatively, or additionally, as shown in FIG. 2, the key fob 20 could include a screen 24 that leads the owner to his vehicle via a directional arrow on the screen. The screen 24 could be any type of visual display including, but not limited to, matrix displays such as thin film transistor (TFT), liquid crystal display (LCD), field emission display (FED), cathode ray tube (CRT) or singular type displays such as light-emitting diodes (LEDs) and lamps. Depending on the network 10 structure, the locator node 16 may be capable of conveying to the owner the vertical distance between the locator node 16 and the target node 12 in the case where the vehicle is in a multiple level parking structure. Additionally, depending on the locating system 22 capabilities, and ranging techniques used, in addition to the direction the distance to the target node 12 could be conveyed to the owner via the key fob 20.

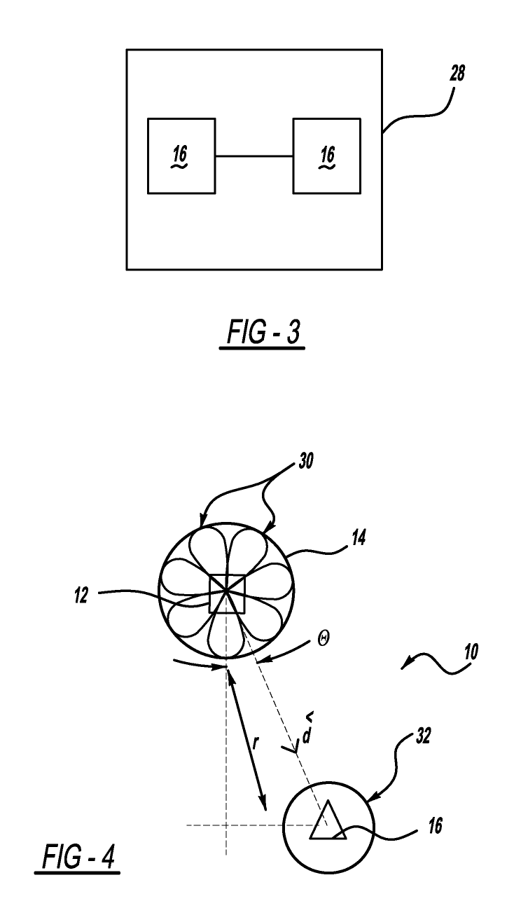

The target node 12 can be incorporated in the vehicle in multiple ways. One such way is that it is a standalone device that is placed in the car when its use is desired. A more advanced system of the present system may involve the target node 12 being electronically connected with the vehicle's 28 electronic subsystem 26 as shown in FIG. 3. For example, the target node 12 can be configured to be in communication with the OnBoard Diagnostic (OBD) bus interface. The current interface is the OBD-II interface which became mandatory on all cars sold in the United States in 1996; however nothing contained herein is meant to limit connectivity solely to the OBD-II interface. This could occur as an after market add-on or could be installed during vehicle production. Connecting the target node 12 with the electronic subsystem 26 of the vehicle 28 greatly expands the possible functionality of the present system by allowing the locator node 16 to display vehicle status and control vehicle functions remotely.

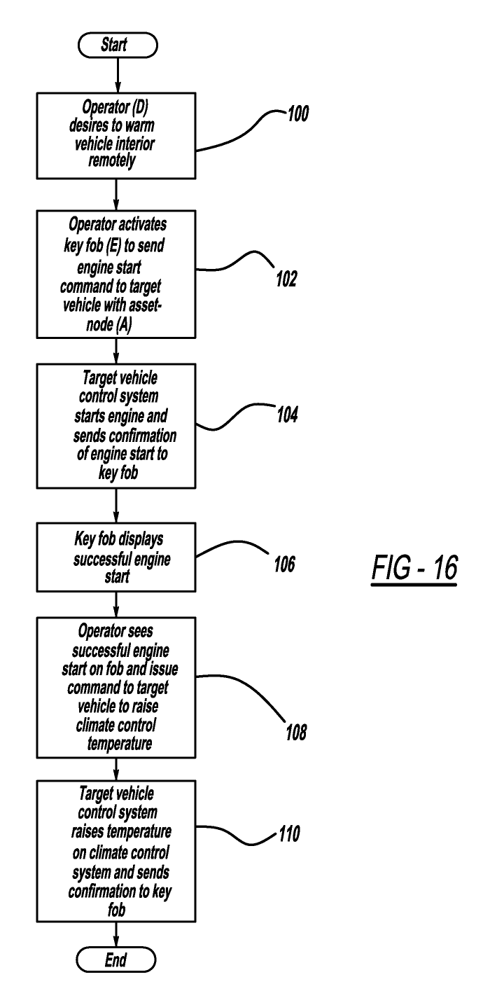

In operation, for example, an owner could remotely place her vehicle windows in a closed position if she realizes it is beginning to rain even while she is sitting in her office building, she could start and control the temperature of the vehicle prior to getting into the vehicle, she could be alerted if her vehicle was moving without being started by her (i.e. stolen), and/or she could confirm that her vehicle doors are locked. If the key fob 20 includes a screen 24 then the operation of the vehicle's systems and the status of the vehicle can occur via the screen 24. Referring to FIG. 16, a preferred method of operating the climate control via the key fob 20 is shown. First, in step 100 the operator decides to warm vehicle interior remotely so in step 102 she activates the key fob to send an engine start command to the target node (her car). Then, in step 104, the vehicle system of the target vehicle starts the engine and confirmation of the engine start is communicated back to the key fob. In step 106, the key fob displays a message indicating that the engine start was successful and in step 108 the operator uses the key fob to further control the climate control temperature. Finally, in step 110 the target vehicle control system adjusts the temperature accordingly and sends a message back to the key fob indicating success. She could also view other vehicle information including the vehicle's tire pressure, gas gauge, oil change status, and other maintenance issues. It is anticipated that practically every vehicle control/function can be controlled via the present invention if the target node 12 is connected to the electronic subsystem 26 of the vehicle and more possibilities are disclosed hereinbelow.

Referring now to FIG. 4, one possible variation of the network 10 with only two nodes is disclosed. In FIG. 4, the type of antenna utilized by the target node 12 is not the omnidirectional antenna as shown in FIG. 1 but instead the target node 12 has multiple directional antennas 30. Utilizing multiple antennas at the target node 12 enables both two and three dimensional range measurements to be determined.

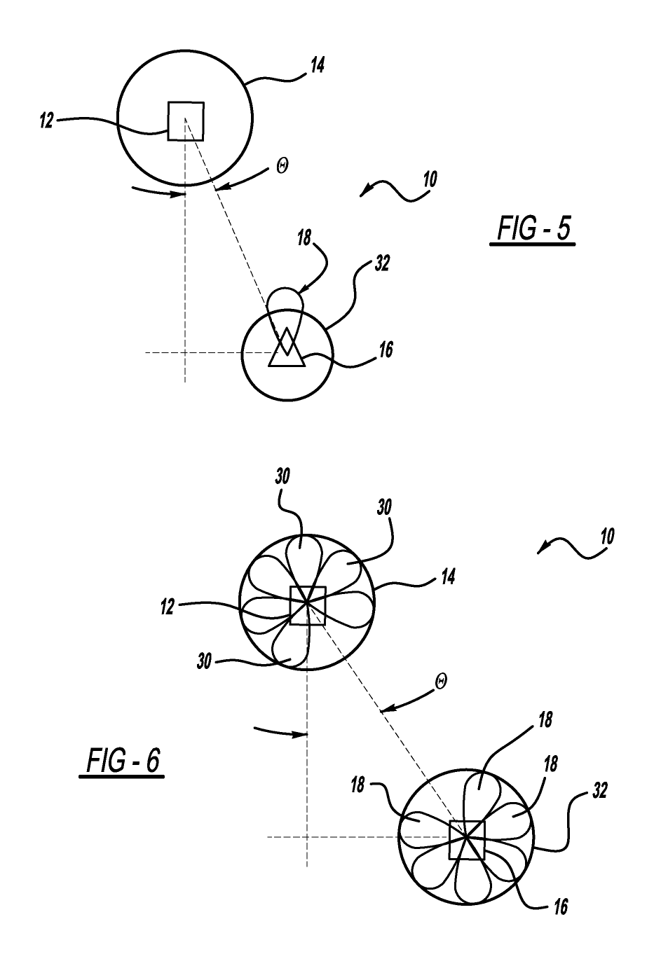

Another possible variation of the network 10 is shown in FIG. 5. In this variation, the locator node 16 could include both an omnidirectional antenna 32 and a directional antenna 18. Such a configuration enables the omnidirectional antenna to be used to initiate communications with the target node 12 without the user having to face in a certain direction to do so, as he would have to do with just the one directional antenna. Once communication is established between the locator node 16 and the target node 12, the user is able to align himself in the direction of the car by optimizing the receipt of a signal from the target node 12 with the directional antenna 32 of the locator node 16.

Yet another variation of the two node network 10 is shown in FIG. 6. As shown in the figure, both the target node 12 and the locator node 16 include an omnidirectional antenna 14 and 32 and multiple directional antennas 30 and 18. It is not necessary that the locator node 16 and the target node 12 utilize the same number or the same configuration of directional antennas 18 and 30. Multiple directional antennas 30 on the target node 12 allow for typical antenna diversity techniques as known in the art to be applied. Also, multiple directional antennas 30 on the target node 12 enable the radiated signal of the target node 12 (for example an RF signal) and/or its received antenna gain pattern to be beam steered. This is advantageous to provide a direction metric for the locator node 16 or can be used in concert with other direction finding mechanisms/techniques. Multiple directional antennas 18 on the locator node 16 are equally advantageous over a single antenna to provide for more accurate communication between the target node 12 and the locator node 16.

As used throughout, the types of antennas discussed have been generalized as two distinct types—omnidirectional and directional. The physical characteristics of both of these types can be any one of combination of known antenna types which include but are not limited to monopoles, dipoles, horn, helical, log-periodic, loop, microstrip, dish, parabolic, patch, phased array, planar array, and slot. Additionally, one skilled in the art shall realize that these antennas may be configured to specifically provide gain (or nulls) in one, two, and three-dimensional space.

As one skilled in the art will appreciate, the above variations show that there are numerous combinations/configurations possible depending on the needs of the application. One skilled in the art will also appreciate that a two node system is the most basic application of the disclosed system. Full realization of the functionality and potential of the disclosed system is not obtained until there are more than two nodes. Using the basics from the various two node configurations as described hereinabove, it is possible to explore some of the possible configurations of a multi-node network. For simplicity, the multi-node network will be referred to with the same reference as the two node network, as will the locator node and the target node.

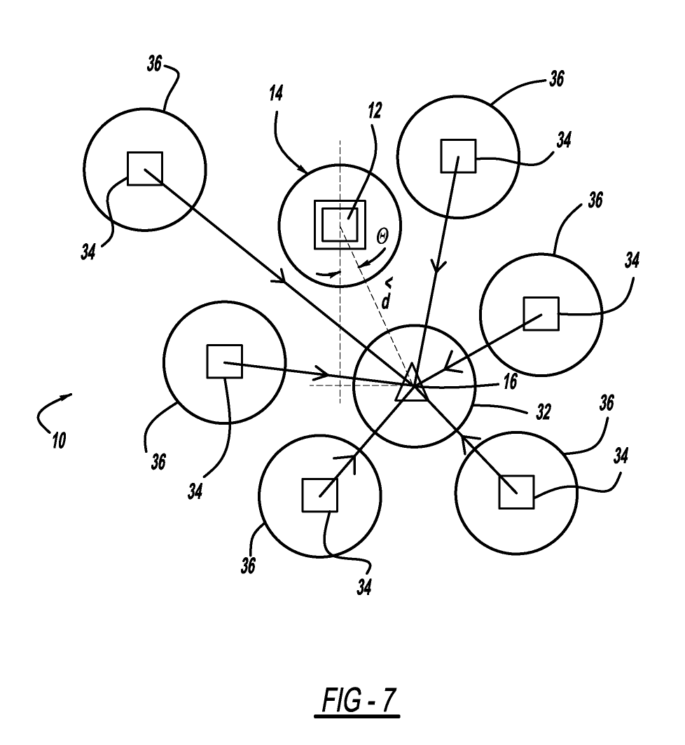

Referring to FIG. 7, there is shown generally one possible configuration of a multi-node network in accordance with the present invention at 10. In this configuration, there is a locator node 16, a target node 12, and multiple helper nodes 34. While the helper nodes 34 in the figure are shown as a finite number, any possible number of helper nodes 34 may be used. Each of the locator node 16, target node 12 and helper nodes 34 utilize an omnidirectional antenna 32, 14, and 36. It is anticipated that the helper nodes 34 may or may not be in motion. In this scenario it is assumed that the current locations (relative or absolute) for the helper nodes 34 are known through previous underlying networking protocol processing (i.e. the helper nodes 34 know where each other are ahead of the locator node 16 communicating with the network 10 of nodes). Upon entering and communicating with the network 10, the locator node 16 sends a communication signal which is them received by the helper nodes 34 and the target node 12. Ranging calculations are performed using any number of the various ranging techniques described hereinabove for each of the helper nodes 34 and the target node 12. The information obtained from the ranging calculations is then used so that a refined range and direction metric for the target node 12 is determined. Preferably, time difference of arrival (TDOA) ranging technique is used but any number of the other ranging techniques is possible. If any of the helper nodes 34 are in motion, it is anticipated that the motion of such helper nodes 34 may fuse additional measurement data into the ranging and/or direction calculations. Such data could be obtained and calculated using Doppler techniques. The increase in the number of helper nodes 34, especially if the current location (relative or absolute) of any of those nodes 34 is previously known, the accuracy of the calculated location of the target node 12 is increased. It is further noted that no assumptions can be made with respect to the altitudes of the helper nodes 34 and in fact those on different vertical planes (i.e. different floors of a parking structure) may aid in providing for ranging accuracy. In this example, while the helper nodes 34 are utilized to help determine and refine the location of the target node 12, the ranging technique relies on the target node 12 to determine the range and direction metric. Alternatively, it is possible to use the target nodes 12 in a slightly different manner.

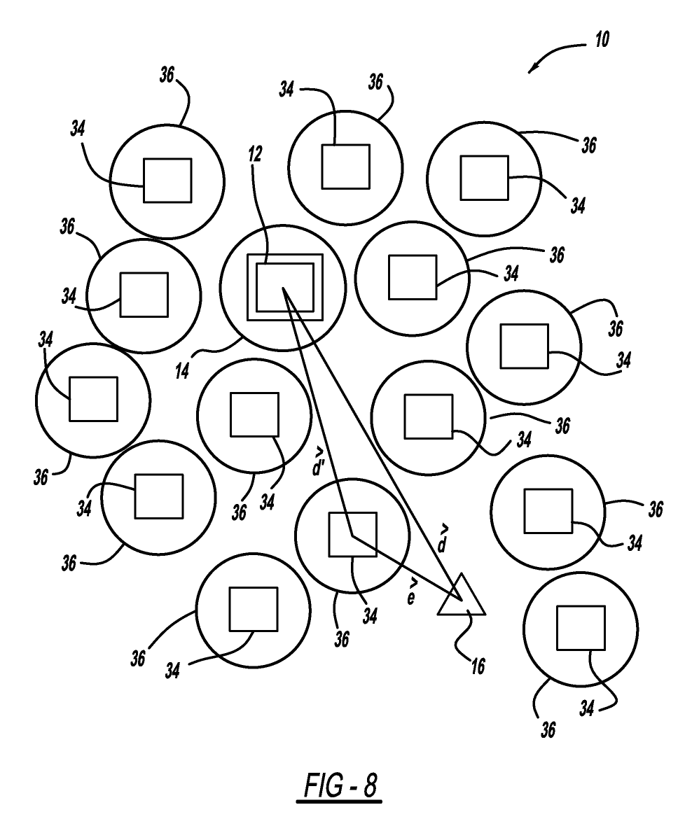

Referring to FIG. 8, the locator node 16, the target node 12 and the helper nodes 24 again utilize omnidirectional antennas 32, 14 and 36. In this scenario, the range and direction metric of the target node 12 is approximated by using the range and direction metric of the helper node 34 closest to the locator node 16, not necessarily the target node 12. This enables the locator node 16 to “use” the closest helper node's 34 location information which reduces the need for the locating system 22 to perform multiple calculations and reduce the need for any explicit lateration technique to be performed. Of course this scenario works the best if the closest helper node 34 and the target node 12 know their current location (relative or absolute) within the network. It is anticipated that if the current location of the target node 12 is known, the known location of a helper node 34 closest to the target node 12 could be utilized to approximate range and direction. This closest node technique is advantageous not only because it potentially reduces the amount of system requirements necessary to compute and determine ranges, but it also could afford the locator node 16 a significant reduction in required power to receive and send high quality signals since it would only need to communicate over short distances (i.e. between the locator node 16 and the closest helper node 34 versus between the locator node 16 and the target node 12). Therefore, it is advantageous to have a multi-node network wherein the various nodes interact and can be used as intermediaries to communicate with other nodes rather than a simple one-to-one relationship between nodes.

As mentioned hereinabove, but worth mentioning again, the network 10 may be configured so as to use multiple types of communications protocols. For example, the helper nodes 34 and target node 12 can send and receive signals via one type of wireless communication protocol amongst themselves but all communication with the locator node 16 is via a different protocol such as RFID.

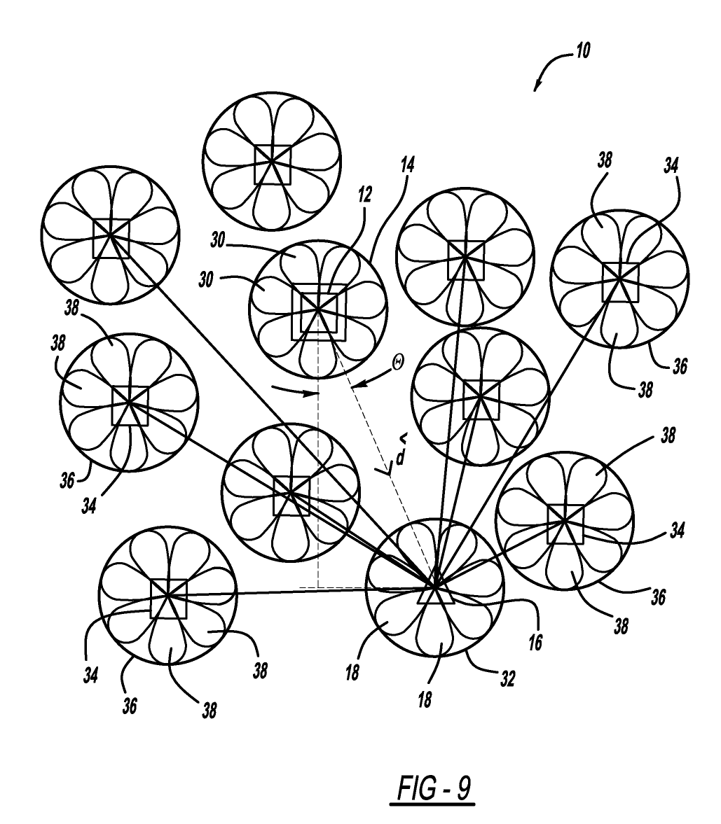

Similar to as described above for FIG. 6, a multi-node network 10 can be enhanced with multiple antenna configurations for the helper nodes 34, the target node 12, and/or the locator node 16. Referring to FIG. 9, a multi-node network 10 wherein the helper nodes 34, the target node 12 and the locator node 16 all utilize omnidirectional antennas 36, 14 and 32 and multiple directional antennas 38, 30, and 18 is shown. As stated above, the antenna configurations for each of the types of nodes 12, 16, and 34 is not necessarily the same. A multiple antenna configuration for the helper nodes 34 and/or the target node 12 allows for classic antenna diversity techniques to be applied by picking the best technique and/or directional antenna for the situation. Also, multiple antennas can be used to beam steer both sent (radiated) communications signals and/or received signals. This can be used to solely provide the direction metric for the locator node 16 or can be used in concert with other direction finding mechanisms such as angle-of-arrival techniques. Multiple antennas in the locator node 16 can be used in a similar fashion and may provide for more favorable results and uses than can be realized with a single antenna.

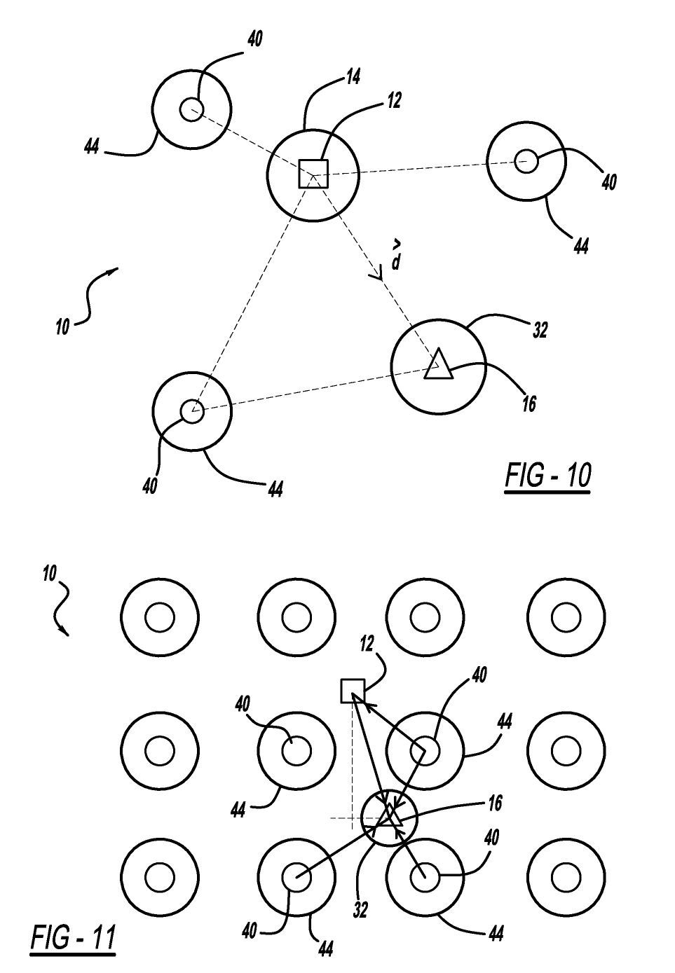

The above multi-node examples all anticipate that the helper nodes 34 are movable (for example located in vehicles). Further advantages can be obtained by incorporating fixed helper nodes 40 in the system. Referring to FIG. 10, there is shown a multi-node system incorporating three fixed helper nodes 40. In this system configuration, the fixed helper nodes 40 are positioned at known geographic coordinates. Each of these fixed helper nodes 40 communicate with both the target node 12 and the locator node 16 and as a result, the relative range and detection metrics of the locator node 16 with respect to the target node 12 can be determined. This information can be broadcasted individually to the target node 12 and/or the locator node 16 or unicasted to each with the same message/signal. Using at least three fixed helper nodes 40 enables the relative position of the target node 12 and the locator node 16 to be determined in a three dimensional space, especially when using a technique such as AOA. One skilled in the art will appreciate that more than three fixed helper nodes 40 may be utilized. One skilled in the art will also appreciate that the use of fixed nodes may have advantages in terms of power availability which allows for the use of higher power transmitters, more sophisticated and sensitive receivers, more complex modulation/RF transceiving techniques such as Direct Sequence Spread Spectrum (DSSS), frequency hopping, and high order multiphase and amplitude modulation techniques, and the possible use of higher order signaling methods to augment or replace more common standard protocols. Preferably, any fixed nodes are also mounted high with respect to the mobile nodes as doing so increases the line of sight advantages, which provides for more robust RSSI measurements and decreases obstructions.

Referring to FIG. 11, there is shown a multi-node network 10 with more than three fixed helper nodes 40. There is no limit as to the number of fixed helper nodes 40 that may be incorporated. In this example, the location information is similarly derived as explained above. Also, as described above, the use of more fixed helper nodes 40 may facilitate lower transceiver power requirements in both the target node 12 and the locator node 16. One skilled in the art will appreciate that in this example the same approximation methods as described hereinabove may be utilized, especially the nodal approximation method as described above in reference to FIG. 8.

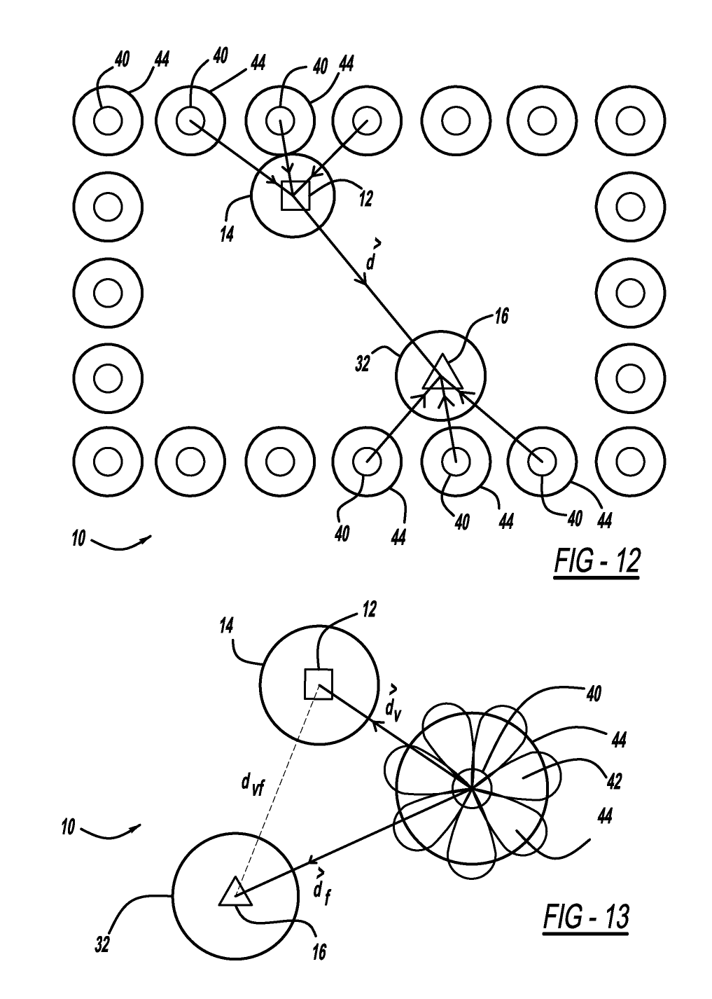

Referring now to FIG. 12, a variation of the network 10 of FIG. 11 is shown. The network 10 of FIG. 12 utilizes multiple fixed helper nodes 40 in a specific arrangement distributed along the physical perimeter of the defined network area at known geographical coordinates. Such a configuration allows for additional accuracy and also allows for the helper node 40 antenna configuration to be such that the “field of view” of the antennas is reduced or directed within a particular area. This can provide physical security for rejecting unauthorized/unwanted nodes located outside the physical confines of the network to communicate with the network. This can also provide for easier facilitation of passive RFID or other known technologies whose operation can be simplified and/or enhanced by limiting their use to known choke points or high traffic areas. If used with vehicles, areas such as entrances and exits, garage door openings, etc. would be likely applications for this configuration.

Yet another possible configuration of a multi-node network 10 in accordance with the present invention is shown in FIG. 13. In this configuration there is shown a locator node 16, a fixed helper node 40, and a target node 12. Preferably, the fixed helper node 40 has a multitude of directional antennas 42 and an omnidirectional antenna 44. A subset of these antennas is configured in a geometric pattern which constitutes a phased array system of antennas. The target node 12 and locator node 16 can communicate directly with the fixed helper node 40 and/or with each other. Directional and ranging metrics for both the target node 12 and the locator node 16 can be calculated by the fixed node 40. Alternatively, the vehicle can communicate its predetermined location data if known.

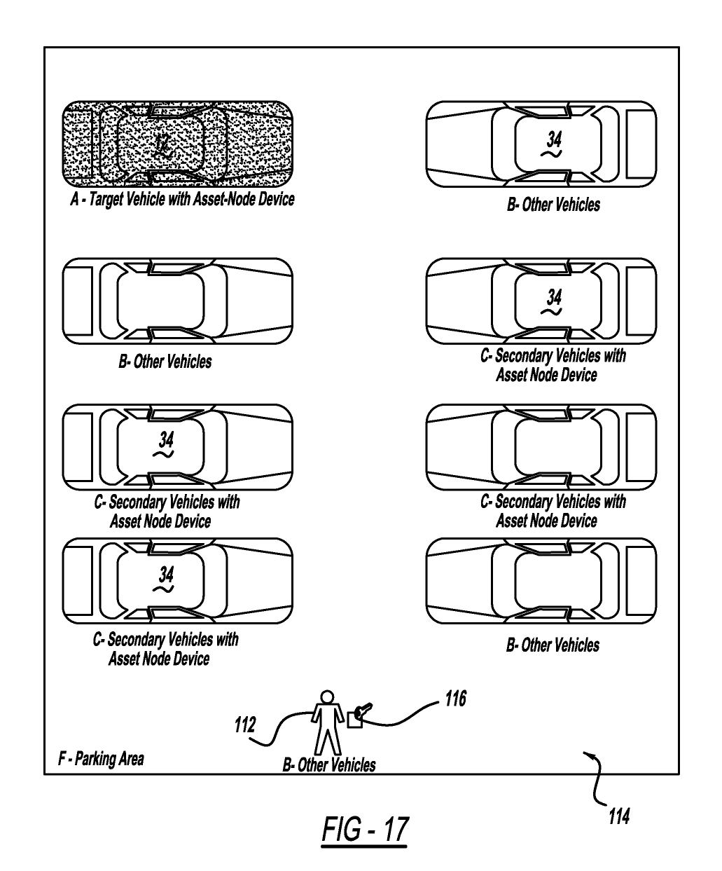

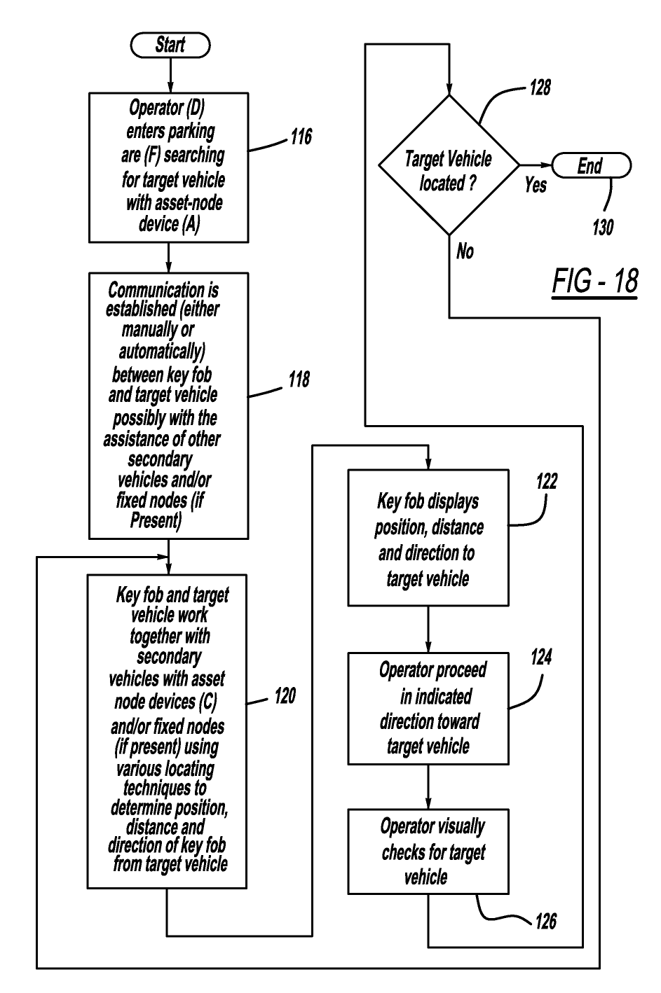

As an example of an operator 112 entering a parking lot 114 with multiple nodes (helper nodes 34) and the preferred method for locating his car (target node 12) in accordance with an embodiment of the present invention, refer to FIGS. 17 and 18. Preferably, the process starts at step 116 with the operator entering the lot 114 and deciding to use the location assist feature to find his car. In step 118, communication is established (either manually or automatically) between the key fob 20 and the target node 12 vehicle possibly with the assistance of helper node 34 vehicles (if present). In step 120, the key fob 20 and target node 12 work together with the helper nodes 34 using various locating techniques to determine position, distance, and direction of key fob 20 from target node 12 vehicle. Next, in step 122 the key fob 20 displays the position, distance, and direction to the target node 12 vehicle. In step 124 the operator proceeds in indicated direction towards target vehicle. In step 126 operator visually checks for target vehicle and decides whether it has been found in step 128. If the operator has found his car the process ends at 130 otherwise the process preferably returns to step 120.

One skilled in the art will appreciate that the foregoing and the accompanying figures are meant to be examples of the possible configurations of a network in accordance with the present invention. It should be appreciated that neither the specific configurations nor descriptions of techniques used are meant to be limiting to the scope of the present invention. For example, different configurations of target nodes, helper nodes, and locator nodes could be utilized. Further, different antenna configurations could be used and could vary within one network. Even further, in the case of the network being utilized with vehicles, the nodes within the vehicles could be portable units which are placed in cars for a limited amount of time, the nodes could be integrated with the vehicle itself and interfaced with the vehicle electrical system, or the nodes could be a combination of portable and integrated nodes. Further, the nodes could utilize or be incorporated within GPS units to use and provide detailed location information. Due to an unlimited upper limit on the number of nodes, the number of antennas on each node, and the number of different ranging techniques available, the possible number of configurations is endless and the discussions hereinabove are intended to anticipate all such configurations.

As stated herein, one of the objects of the present invention is to develop a single unified foundation system that can be utilized either without modification or with additional added system components by many different entities. It is a goal to have a system that has more than one main purpose for one user as is the often the case. As also stated herein one preferred application of the disclosed system is to have the nodules in vehicles. As described above, if incorporated into a vehicle and connected to the electrical system of the vehicle, the system can provide many benefits for the owner/user of the car. Even if not incorporated into the vehicle, a portable node in the car to use with a network system. This portable node may or may not interface with the electrical system of the vehicle. In accordance with one of the objects of the present invention, however, the system can benefit not only the end user of the vehicle but others involved during with the vehicle during its “life” and therefore has multiple uses and functions for many different people in the chain. Therefore, as mentioned previously, a preferred embodiment utilizing the communication network previously disclosed is a vehicle dealership asset tracking system.

The task of maintaining, managing and selling vehicles requires a large commitment in resources—human, financial, and time. The purpose of this system is to allow dealership personnel to easily locate, interrogate, control and process vehicles from the time they enter the dealership to the time they are sold and even after the sale. This system enhances productivity, increases sales, and reduces losses do to problematic or damaged vehicles, all of which contribute to greater profits for the dealership.

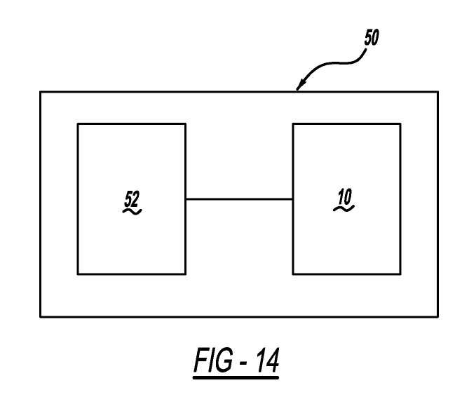

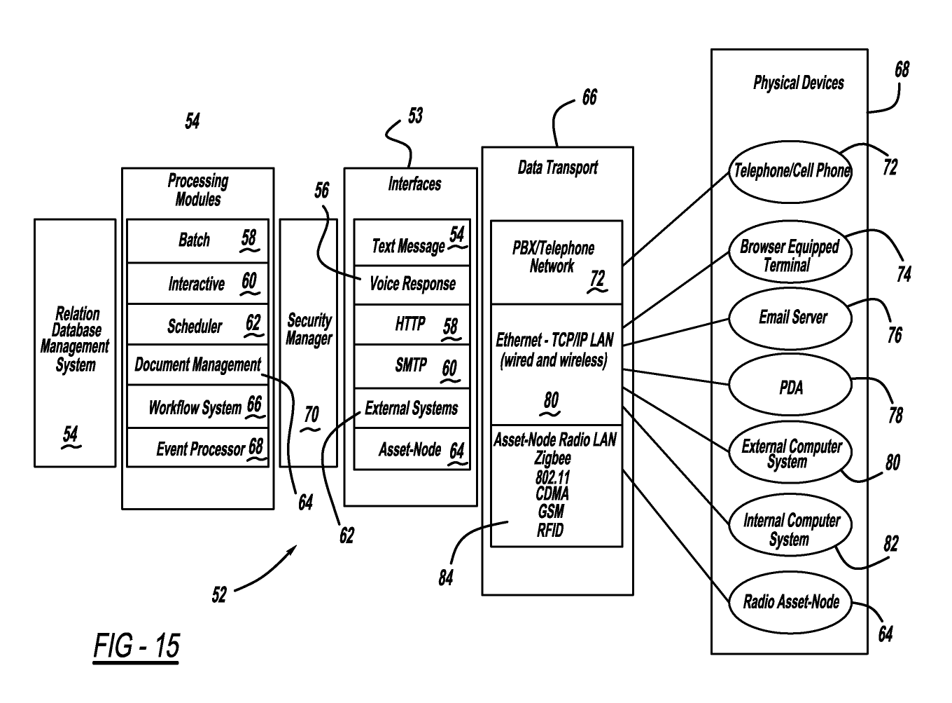

Such an asset tracking system involves the addition of an information technology platform to serve as the master control system to interface with the network 10. Referring to FIG. 14 the asset tracking system is shown generally at 50 and utilizes a node network 10 as described herein. The asset tracking system 50 uses a master control system 52 to interface with the network and to provide a user interface. Referring now to FIG. 15, a high level diagram of the components preferably included in the master control system 52 is shown. The components are integrated together to provide a system 52 to store, manage and use the information collected from the other parts of the system. The master control system 52 preferably includes a relational database management system 54 and various processing modules 56. The processing modules 56 preferably include a batch processor 58, an interactive processor 60, a scheduler 62, a document management system 64, a workflow system 66, and an event processor 68. The types and functions of processing modules 56 will vary by the intended use and functionality of the system. The master control system 52 should also include a security managing system 70. Security is preferably implemented at every level in the system so as to limit unauthorized use and to allow a user/permission scheme which limits what data a user can access and what actions a user can take based on the user's permissions level (usually depending on the user's role in the organization). Security may be implemented with any number of known methods of encrypted radio and internet protocol network traffic.

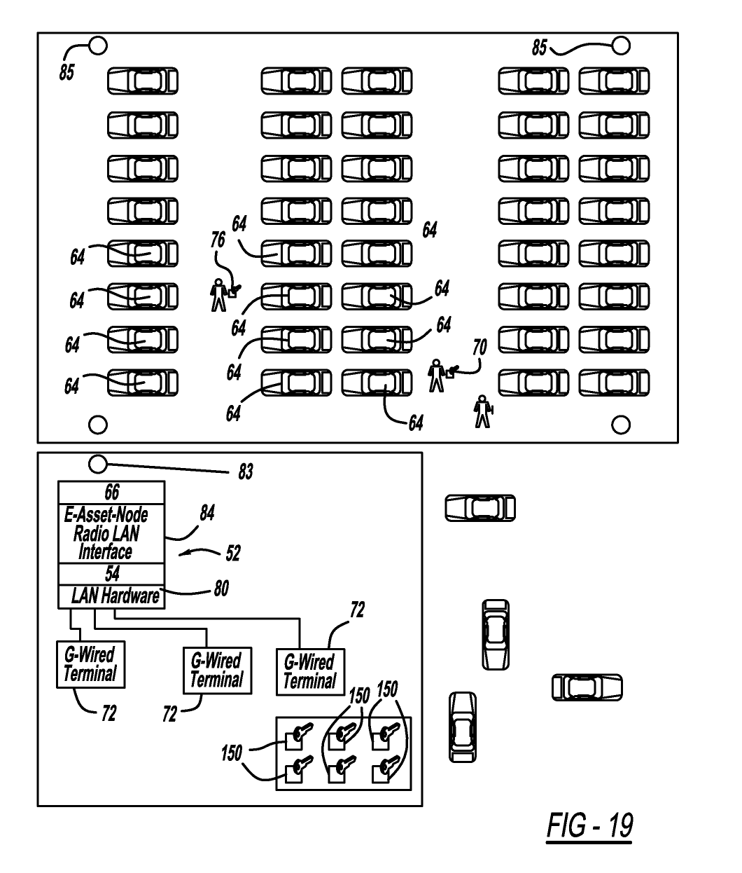

Ideally, the master control system 52 shall accommodate a number of different interfaces 53 in order to communicate system data to users. Such interfaces preferably include text (SMS) messaging 54, voice response 56, HTTP 58, SMTP 60, external systems 62, and asset (or tracking) node 64. The interfaces 53 require different data transport protocols 66 and are used by different types of physical devices 68. For example, the text messaging 54 and voice response 56 interfaces will be most likely utilized by a telephone/cell phone 70 which preferably operate using a PBX/Telephone network 72. The HTTP 58, SMTP 60, and external systems 62 interfaces will preferably be utilized by a browser equipped terminal 72, an email server 74, a PDA 76, or an external computer system 78. These physical devices 68 will preferably transport data with the master control system 52 via an ethernet, TCP/IP LAN 80 either wired or wireless. Finally, the asset node 64 which is located in the asset to be tracked, in this example a vehicle, and internal computer systems 82 which are part of the dealership in this example, preferably transport data with the master control system 52 asset node LAN 84 via a type of wireless communication protocol such as Zigbee, 802.11, CDMA, GSIM, and/or RFID. As stated herein, the system may involve multiple types of wireless communication on the same network. Referring to FIG. 19, the system 52 may also include the use of a building antenna 83 and/or range extending routers 85 to increase the distance of the wireless signals.

With the disclosure of the node network and the description of the preferred components of a master control system 52 for asset tracking, a few examples of how the entire system can be utilized together is necessary to appreciate the functionality and the varied uses of the present invention. For each of the following examples, the master control system 50 preferably controls communication with each of the asset nodes/tracking devices 64 (which are akin to the nodes as described hereinabove and change function between helper node 34 and target node 12 depending on the situation) and provides the interface for the user to use the system 50.

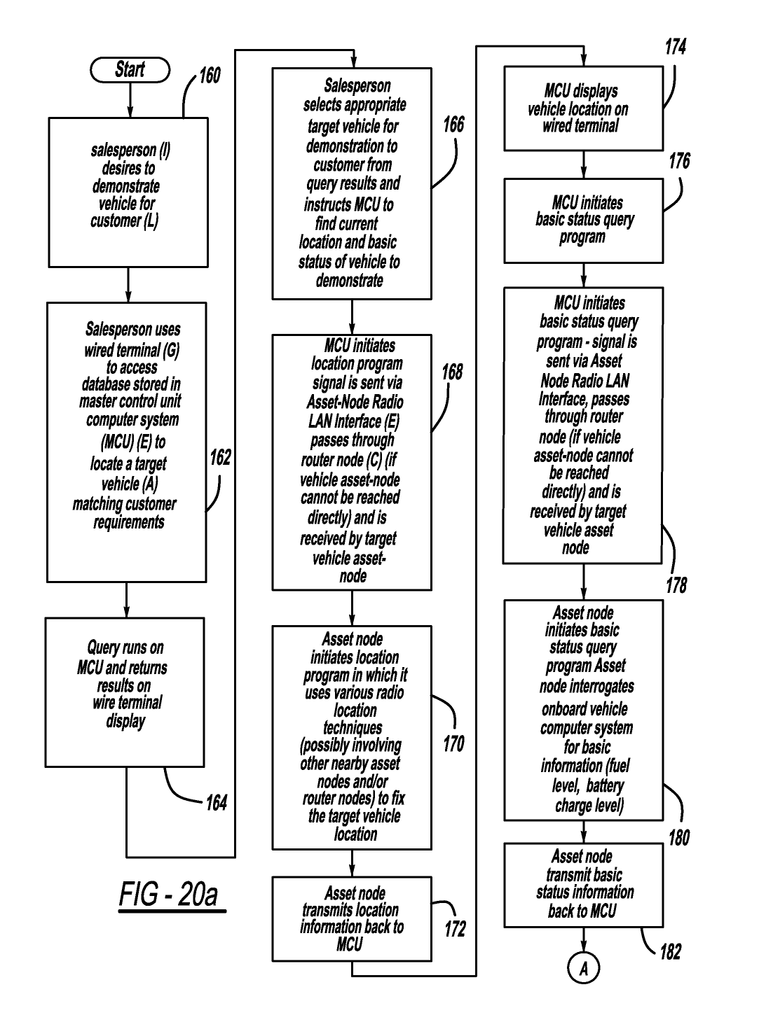

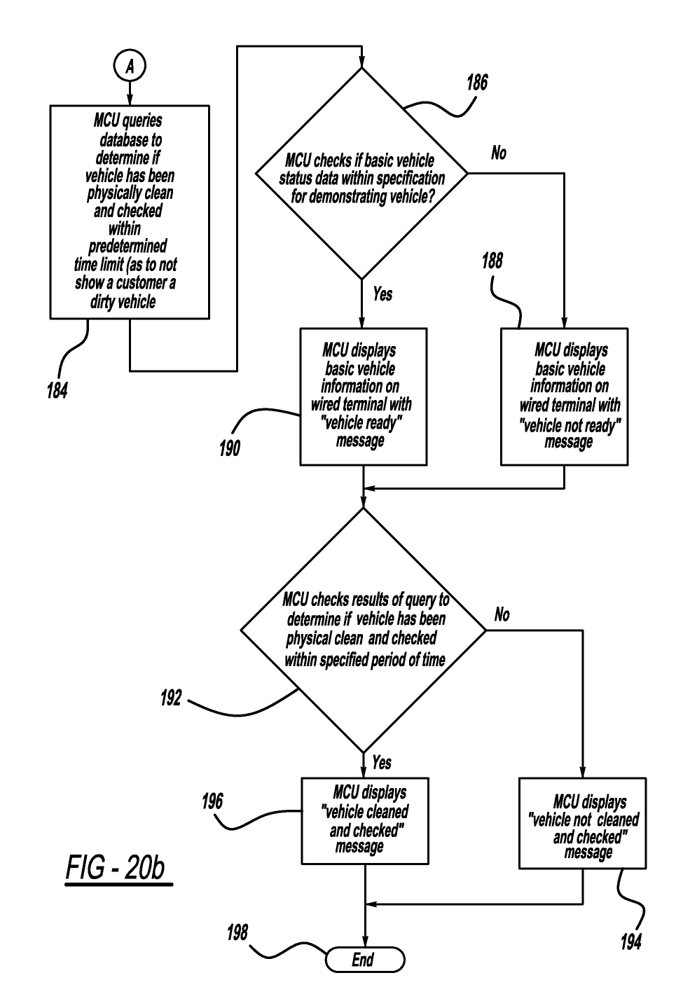

Similar to the process described above when an owner wants to find his car in a parking lot, the system can also be used to locate cars at the dealership. A long standing problem for vehicle dealers is the ability to locate particular vehicles on the dealer property in a reasonable amount of time. A typical dealer may have hundreds or thousands of vehicles on the dealer property at any given time. As these vehicles are moved around the property for various reasons (sales to customer, new inventory deliver, cleaning, showing to potential customers, etc.) it is extremely difficult to know the location of any vehicle at any time. Current methods of keeping track of vehicle location require human data collecting and reporting and therefore it subject to human error or just simply not being done at all. This is problematic for the vehicle dealer in many ways. It wastes resources and time locating vehicles and potentially loses sales if a particular vehicle cannot be located on the dealer lot in time to please the customer. A preferred method for how a vehicle location might be determined using a dealership system 50 is shown in FIGS. 19 and 20. While each of the vehicles as an asset node 64 installed, for purposes of this explanation, the original terms of target node and helper node will be utilized since each asset node 64 is either the target node or a potential helper node.

Referring to FIG. 20, the process starts at step 160 when the salesperson desires to demonstrate a vehicle for a customer. In step 162, the salesperson uses a wired terminal 72 to access the database 54 which is part of the master control unit 52 to locate a target node 12 vehicle matching the customer's requirements. In step 164, the query runs on the master control unit 52 and returns the results to the salesperson via the terminal 72. Then, in step 166, the salesperson selects the appropriate target vehicle and instructs the master control unit 52 to find the current location and basic status of the vehicle. In step 168, the master control unit 52 initiates the location program and sends a signal via the asset node radio LAN 84 to the target node 12. If the target node 12 cannot be reached directly, the signal may travel through an antenna 83, a router 85 and/or helper nodes 34. Then, in step 170, the master control unit 52 utilizes various radio location techniques as described herein to find the target vehicle location. In step 172, the target node 12 transmits location information back to the master control unit 52. In 174, the master control unit 52 displays the vehicle location on the wired terminal 72. Next, in step 176, the master control unit 52 initiates the basic status query to obtain the status of the target vehicle causing the signal to be sent to the target node 12 in step 178. In step 180, the target node 12 interrogates the onboard vehicle computer system for basic information such as fuel level, battery charge level, etc. Then, in step 182, the information is transmitted back to the master control unit 52. In step 184, the master control unit 52 queries a database to determine if the vehicle has been physically cleaned and checked within a predetermined time. Then, in step 186 the master control unit 52 checks if the basic vehicle status data is within the predefined specification for demonstrating the vehicle. If the answer is yes, then in step 190 the master control unit 52 displays a vehicle ready message on the terminal 72 and continues to step 192. If the answer was no, then in step 188 the master control unit 52 displays a vehicle not ready message on the terminal 72 and continues to step 192. In step 192 the master control unit 52 checks if the vehicle has been cleaned within the specified time. If yes, the master control unit 52 causes a “vehicle cleaned and checked” message in step 196 to let the salesperson know the vehicle can be demonstrated and then the process ends in step 198. If no, the master control unit 52 causes a “vehicle not cleaned and checked” message in 194 to let the salesperson know the vehicle should not be demonstrated and then the process ends in step 198.

Another example of a possible function of the asset system is for checking new vehicles into dealer inventory. Typically, when a new vehicle arrives at the dealership, information about that vehicle needs to be manually entered into the dealership computer system. To simplify this task, if an asset node 64 has not been installed in the vehicle during the manufacturing process, a standalone asset node (not shown) can be installed in the vehicle immediately after it arrives at the dealership. This asset node has the same characteristics and capabilities of the nodes as previously described herein enabling it to communicate with the network. As soon as the node detects that it has been installed in a vehicle 28 it can communicate with the vehicle systems 26 and transfer that information to the dealership computer system 82 via the master control unit 52. The information could contain all of the information available in the vehicle computer system for example vehicle identification number, vehicle manufacturer, vehicle model, installed options, vehicle color, etc. Having the vehicle information automatically entered into the dealership system saves time and expense for the dealer and makes the dealership operation more efficient. It frees personnel from the task of manually recording the data and then entering it into the computer system and as a result makes the vehicle instantly available for sale. If a customer requests a vehicle it is more likely that his request will be filled. This may result in a sale that may otherwise have been missed if the vehicle was on the dealership property but not known because it was waiting to be checked in. This also increases customer satisfaction because the customer does not have to wait for the vehicle desired or settle for a vehicle other than requested.

Another example of the use of the tracking system 50 includes the securing of vehicles at the dealership at the close of business or when desired, such as in the event of precipitation. At the close of business each day the vehicle monitoring system could be activated to perform a check of all vehicles. The system would communicate with every vehicle at the dealership and determine if every vehicle had its doors locked, its windows in the closed position and the interior and exterior lights off. If any vehicles were found to have unlocked doors, windows in the open position or interior or exterior lights on the user of the system could issue a command to lock the doors of the vehicles, move the windows to the closed position and turn off interior and exterior lights. This could also be performed as macro command such as “secure all vehicles” where the system would automatically interrogate every vehicle and issue commands to rectify any unlocked doors, windows in the open position or vehicle lights on. This system could also be used to either manually or automatically move all windows to the closed position in the event of precipitation. This could reduce theft and vandalism of vehicles after business hours. It could also reduce damage to vehicle interiors due to precipitation. Any instances of vehicles being unlocked, windows open or lights on would also be recorded in the system. This information could later be combined with other records of vehicle/employee interaction (see other example for recording of vehicle/employee interaction) to address the issue of proper vehicle care with errant employees.

In yet another example of the possible functionality of system 50, the temperature inside the car could be remotely controlled before a vehicle demonstration. Similar to as described for FIG. 16, but using the system 50 instead of the key fob 20, a salesperson could use the system to send a command the vehicle to start the engine. After starting the car remotely the salesperson could then issue a second command using the system to activate and adjust the climate control system in the vehicle to warm or cool the vehicle to the desired temperature. When the vehicle interior reached the desired temperature the salesperson could then be alerted at his system terminal 72 and/or other communication device (cell phone 70, PDA 76, email 74, etc.) that the vehicle was ready to be shown to the customer. While the vehicle was warming/cooling the salesperson can continue to focus on the customer and the sales process instead of spending time locating and warming/cooling the vehicle. This would provide a comfortable environment for the customer to inspect the vehicle and contribute positively to the sales experience.

Another example of a use of the system 50 is for recording and reporting vehicle data while in dealer inventory. It is desirable for dealership management to know information about vehicles in the dealership inventory as the vehicle moves through the sales process. Desired data might include but are not limited to the number of times a vehicle has been demonstrated to customers and the mileage driven in demonstrations. Each time a vehicle is demonstrated it could be logged in the system by the salesperson at the start and end of the demonstration. At these indications the system would automatically record that a demonstration had taken place, note the date and time of the demonstration, the length of time the demonstration took, the demonstrating salesperson, the customer who the vehicle was demonstrated to and the mileage driven in the demonstration. This information could then be consolidated and processed into useful reports for the dealer management on a periodic basis. Additionally, alerts could automatically be generated based on certain predefined criteria, for example excessive mileage during a demonstration or use of cars that are not to be driven such as high end or limited addition vehicles. The alerts could be delivered in a variety of ways to dealership management e.g. cell phone, pager, PDA, email, etc. This helps the dealership management ensure that salespersons are engaged in the sales process and reduce the abuse of vehicles in inventory.

Yet another example of a use of the tracking system 50 is for recoding vehicle information for sales processing. During the processing of a vehicle sale certain information about the vehicle must be recorded and entered on forms. An example of one of these forms is the odometer form which shows the vehicle mileage at the time of sale. To get the required data for this form, the current value on the odometer must be known. Using the system a salesperson could get this and other required data without leaving the customer. This makes sale process more efficient which save salesperson time and increases customer satisfaction.

Another beneficial use of the system 50 is the use for maintenance, simple diagnostics and vehicle checks on the entire vehicle inventory. In order to maintain and protect valuable dealership inventory it is desirable to monitor vehicle systems for issues that may arise over time as the vehicles move through the sales process. It is important to make sure cars are cleaned and physically checked from time to time. It is important to monitor various aspects of the vehicles to make sure they are ready to demonstrate at any time. Dealership service personal could use the system to either manually review each vehicle in the inventory or issue a macro command to interrogate each vehicle and report any issues detected by monitoring system on each vehicle. Thousands of data points are continuously monitored by the computer systems in modern vehicles and any anomalies can be detected and reported by the system. Examples of the many issues that could occur are poor starting and idling, high idle speed, emissions failure, hesitation/misfire and stalling and excess fuel consumption. Other vehicle systems can be checked for issues that would impact the ability to demonstrate the vehicle such as low fuel, low tire pressure, low windshield washer solvent, low battery level. The system could be configured to automatically interrogate the entire inventory periodically and alert dealership personnel when issues are discovered. The alerts could be delivered in a varieties of ways to dealership management e.g. cell phone, pager, PDA, email, etc. These incidents would also be recorded in the dealership system computer so that a history of each vehicle while it is in inventory can maintained. Vehicles with reoccurring problems can be singled out for further attention, reporting and/or remediation with the manufacturer. Vehicles could also be programmatically scheduled by the system for periodic cleaning and checking. For example a vehicle might need to by washed and checked twice a month. Each day the maintenance department would be notified by the system which vehicles required cleaning and checking. As they cleaned and checked each vehicle a record of the activity would be entered into the system for future reference and be used by the system to schedule the next cleaning and check activity. The record of cleaning could be automatically recorded if the system where configured to recognize that a vehicle entering the cleaning area of a dealership for a period of time indicates that it has been cleaned and checked. By making it easy to monitor vehicle status, correct product issues and keep the vehicles maintained the system allows the dealer to protect his investment in inventory. This type of system use ensures that vehicles are clean, problem free and ready to be demonstrated to a customer. This feature an also be used when an owner brings his car in for maintenance so that the maintenance personnel can quickly and easily gather system information from the car.

Yet another example of how the system 50 could be used is for vehicle recall purposes. Periodically vehicle manufactures will issue updates to their products in the form or firmware updates to the computer systems in the products themselves. These product updates are time consuming to perform because each vehicle in the dealership inventory that requires the firmware update must be physically located and then physically visited by a technician with a device that must be connected to the vehicle computer system. Using this system 50 these updates can be systematically applied to each vehicle so long as the node is electrically connected to the vehicle computer system. The updates could be manually applied one by one using the system 50 or automatically by instructing the system 50 to identify each vehicle requiring the update and then delivering the update via the system network. This would save dealership personnel time and effort and increase the efficiency of the dealership. Additionally, as customers return vehicles to the dealership for routine or incidental service, vehicles requiring updates could be automatically flagged and updated using the system 50. This increases customer satisfaction by quickly and proactively addressing updates and increases the efficiency of the dealership personnel by prevented the need to physically locate and connect to the vehicle to deliver updates.

Another potential use of the system 50 is for floor plan check simplification. Most vehicle dealerships operate on a business model in which the vehicles in the dealership inventory are financed and legally owned by companies known as floor plan providers (FPPs). Whenever a dealership sells a vehicle it is required to report the sale to the FPP in a timely fashion. FPPs require constant checks on the vehicles in the dealership inventory in order to keep track of their assets. Today this process is manually performed by teams of personnel sent to dealerships. The process is time consuming, resource intensive and error prone. These teams physically search for particular vehicles on the dealership property among a large collection of vehicles to reconcile the actual collection of vehicles with an inventory list of the vehicles the dealership should have. It can be extremely difficult to locate a particular vehicle at a dealership. Additional time and resources are spent when discrepancies are discovered. When a vehicle that should be physically present on the dealership property cannot be found it can be difficult to determine if it is misplaced, has been sold but not reported to the FPP or has been stolen. This can require a great deal of time of both FPP and dealership personnel. Using this system 50 the FPP could access the data in the dealership system directly through the Internet to automatically reconcile the dealership inventory with the FPP records. If a particular dealership did not want to grant the FPP direct access to their computer system the dealership personnel could use the system 50 to produce an electronic file containing the contents of the dealership inventory and then deliver that file to the FPP via the Internet. This could dramatically reduce costs for the FPP and the dealership by eliminating the need for FPP personnel to travel to each dealership and spend time physically reconciling the dealership inventory with FPP records. A key component of the system 50 relies on the fact that while installed in a vehicle a tracking node reports the unique vehicle identification number. This would prevent anyone from installing a node in one vehicle and attempting to represent that vehicle as another. This feature would be important to any FPP relying on the system for accurate data.

The nodes of the system 50 can be located and used for purposes other than locating a vehicle. Because vehicles are frequently moved by many different people at a dealership it can be difficult to locate the keys for a particular vehicle. Although business rules may specify that the keys for a vehicle are to be returned to a specific location this rule may be often ignored. Even if keys are returned to a specific location they can be difficult to locate a particular set of keys out of a large collection of keys. This inability to locate vehicle keys negatively impacts sales and dealership personnel productivity. For example a customer may be waiting to see a vehicle but the keys cannot be located. Or a vehicle may be waiting for service but because the keys cannot be found the service person cannot proceed with service. By attaching a key remote tracking device 150 which operates as a node on the network and coded with a unique identifier similar to the tracking device installed in the vehicle to the keys the system can be used to find out the current location of the keys on the dealership property and activate a signal on the key tracking device like a flashing light to further assist in the key location. The unique identifier is linked to the unique vehicle identifier in the systems database so that a set of keys would be associated with a vehicle logically in the system.

Similarly, a tracking device (node) could be assigned to each employee at a dealership. As the employees move about the dealership and interact with vehicles and keys, a record of these movements and interactions can be automatically created and stored in the system. It would be possible to dynamically locate employees and also record details about employee/vehicle/key interaction, e.g. how long an employee had a set of keys or which employee drove a particular vehicle last. This information could be processed periodically to provide various reports, e.g. a vehicle report showing all movements of the vehicle, the duration of the movements, the employee that moved the vehicle and if the vehicle left the dealership property.

Yet another feature and benefit of the tracking system 50 is the ability to offer post-sale functionality to buyers. At the time of vehicle sale the customer could be offered the choice to allow a post sales tracking and control unit to be installed in the vehicle if the vehicle did not have a tracking unit installed during the manufacturing process. This unit can be used to provide better customer service whenever the vehicle returned to the dealership. As soon as the vehicle entered the dealership property a number of actions could automatically triggered by the system. An alert could be sent to the salesperson letting know a customer is present giving the salesperson a chance to interact with the customer and build the sales relationship. An alert could be generated to the service manager advising that the customer and vehicle are present and to prepare to offer routine maintenance. The vehicle records could automatically be displayed on the service manager terminal. A record of the customer visit can be generated which the salesperson or service manager would be responsible for addressing and recording the reason for the visit. Any pending vehicle recalls, technical service bulletins, vehicle system firmware updates or incomplete services calls (the customer may be returning on the availability of parts, etc.) could be forwarded to the service manager for action. A customer satisfaction survey could automatically be generated and emailed or mailed to the customer. All of these events and actions are geared toward managing the customer experience and providing better customer service. This may generate repeat business. Management can also review the records of each visit individually or collectively to evaluate dealership personnel performance.

Additional examples of functionality possible with the tracking system include: immediate access to real time information about what mix of vehicles are in inventory by vehicle attributes, view the maximum vehicle speed attained during a demo ride, list vehicles that have not been demonstrated in a pre-set number of days, track vehicles leaving with third party vendors, send text message alerts if vehicles leave the dealership after a certain time of the night or day of the week, allow the service department to determine a vehicle has not returned from a third-party service provider (e.g. body shop, tire provider, etc.), identify which locations on the dealership lot are “hot spots” for sales activity, download owners manual to vehicle, and immobilize stolen vehicles. One skilled in the art will appreciate that the system as disclosed herein that combines a master control system 52 with a multi-node network 10 in which the nodes are connected to the electrical interface of the vehicle provides numerous possibilities regarding the functionality of the system.

It becomes clear that the variety of uses of the system as described herein are endless and that the master control system 52 can be easily personalized for the needs of a particular industry. Staying with vehicles, the vehicle rental industry would also have great use for a system as described herein. A rental car business must keep and maintain a rotating inventory of vehicles. Customers rent vehicles and return them. It is important for the business to keep track of information such as which vehicles are available, which vehicles are rented out and which vehicles need maintenance and repair. As with the dealership tracking system 50 the full value of the system for the rental industry comes from the tight and seamless integration of the various components which locate, interrogate and control the vehicles as well as the information management platform which records and exploits the information. The information management can interface with existing systems. Using this system will improve customer service and increase repeat business as well as improve efficiency and drive down operating costs. A vehicle rental businesses has many of the same challenges of a vehicle dealership business and therefore many of the examples of use as described above would preferably be incorporated in a rental tracking system. Some additional functionality that may be unique to the industry and therefore require the master control system 52 to be modified include check in and check out functions that record check out and check in data to charge customer accordingly and keeping track of vehicle inventory so as to warn when additional inventory might be needed. Likewise, such a system could be used during the manufacturing process to track the manufacturing process and even track the vehicle after it has left the factory.

If the nodes/tracking devices are automatically integrated into the car or are added as a after market installation, the system of the present invention can be used for a variety of other secondary applications not related to a dealership or vehicle rental industry. An additional unit can be marketed to the customer to place in the home to enable some of these applications. The home base unit (not shown) can communicate and control some vehicle functions. The home control unit may be connected to the Internet or a home computer to deliver additional functions. Because there may be privacy and control issues associated with these modules and functions customers would be given the opportunity to explicitly opt-in or opt-out in these programs. Various incentives could be provided to the customer to allow the use of this system in their vehicle and home or they may choose to use it based only on the utility provided. These modules open up many possibilities for tracking, communication and control outside of systems like a dealership or rental facility. Some of the possible uses include:
(1) Point of Sale Automatic Payment/Ecommerce/Toll Payment—Providing electronic payment information simply by having the vehicle module or key fob present;
(2) Demographic data collection—Allowing outside systems to access data about the owner or vehicle through the key fob or vehicle module;
(3) Direct marketing/location based marketing/vehicle systems state marketing/vehicle attribute based marketing—electronically displaying marketing material or coupons on the vehicle or key fob display based on location or vehicle attributes or system state—For example the vehicle operator might arrive at a gas station and receive an advertisement for windshield washer fluid because his vehicle systems show that the level is low. Or a coupon could be automatically sent to the owner's email address for manufacturer recommended tires for his vehicle;
(4) Stolen vehicle immobilizer—If a vehicle was reported stolen it could be sent a signal for immobilization from special police operated network nodes located in central areas;
(5) Commercial vehicle fleets—download service data to motor pool on arrival or alert dispatch of speed violations;
(6) Remote storage lots—locate, interrogate and control vehicles in remote storage lots—This could be done via the Internet so no personnel need to be physical present to monitor the vehicles on the lot;
(7) Vehicle sea port processors—This application makes it easy to locate specific vehicles to be shipped on a particular truck shipment among a large collection of vehicles unloaded from a ship;
(8) Automatic vehicle info download at owners home—GPS, mileage, etc.;
(9) Track business/personal mileage via physical switch on unit or switch on key fob, mileage data can be uploaded to home computer;
(10) Information such as road conditions, weather, music downloaded to vehicle;
(11) Warranty providers can monitor vehicle maintenance records to offer extended warranties to well maintained vehicles;
(12) Insurance providers can monitor vehicle use data (speed, frequency of use, location of use, accelerometer information, etc.) to offer discounted insurance policy to safer drivers;
(13) Collect customer satisfaction data for dealership, vehicle manufacturer or other entities; and
(14) Customer can access vehicle service records/vehicle information from manufacturer via the Internet.

Outside of the vehicle industry, the network and tracking system as disclosed herein could be adapted for use in a variety of industries. For example, the present invention could be used to track livestock, boats, race participants, kids, pets and any other number of objects. This list nor any of the discussion or examples contained herein are meant to be limiting to the present invention. Instead the examples are provided to explain the number of different uses of the system as disclosed.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A wireless local area network comprising:
a plurality of nodes that receive and transmit communications signals within the wireless local area network, wherein one of said plurality of nodes is a target node; and
a locating processor operatively connected to one of said plurality of nodes for sending and receiving signals to and from said target node and performing calculations based on said sending and receiving of signals to determine the direction of the locating processor from the target node.

2. The system of claim 1, wherein said locating process determines the distance of the locating processor from the target node.

3. A system for locating an object within a monitored area comprising:
a wireless transmitter operatively connected to said object and capable of sending and receiving wireless signals;
a locator device capable of communicating with said wireless transmitter via wireless signals, said locator device including a location processor for manipulating and calculating data derived from said locator device sending and receiving signals to and from said wireless transmitter to determine the location of said wireless transmitter relative to said locator device; and
said locator device further including a display screen for displaying location of said wireless transmitter relative to said locator device.

4. A vehicle tracking system comprising:
a vehicle tag capable of sending and receiving wireless signals and associated with a vehicle; and
a locator device capable of sending and receiving wireless signals to and from said vehicle tag and determining relative position of said vehicle to said locator device by communicating wirelessly with said vehicle tag.

5. The vehicle tracking system of claim 4 wherein said vehicle has an electrical system and said vehicle tag is operatively connected to said electrical system.

6. The vehicle tracking system of claim 5 wherein said locator device can obtain information from said vehicle via wirelessly communicating with said vehicle tag.

7. The vehicle tracking system of claim 5 wherein said locator device can control operations of said vehicles wirelessly via said vehicle tag.

8. The vehicle tracking system of claim 4 further including a database for storing vehicle information.
